(19) United States
(12) Patent Application Publication
(10) Pub. No.: US 2006/0278350 A1
(43) Pub. Date: Dec. 14, 2006

(54) Device to repair vertical blinds

(76) Inventors: Rosa M. Zamarripa, La Quenta, CA (US); Gracie Hamman, Palm Springs, CA (US)

Correspondence Address: LITMAN LAW OFFICES, LTD, PO BOX 15035, CRYSTAL CITY STATION, ARLINGTON, VA, 22215, US

(21) Appl. No.: 11/149,312

(22) Filed: Jun. 10, 2005

(51) Int. Cl. E06B 9/36

(52) U.S. Cl. 160/178.1 V

(57) ABSTRACT

The device to repair vertical blinds is a flat, rectangular body having a crease in the center that divides the body in to two symmetrical flaps. Each flap has a centrally located rectangular aperture that is dimensioned and configured to match the size of the mounting hole on a slat of a vertical blind kit. The device has an upper surface and a lower surface. A thin strip of adhesive is disposed along the outward edge of the upper surface of each of the flaps for attaching the device to the damaged slat. The device is constructed from flexible material and may be transparent, opaque, or colored.

### BACKGROUND OF THE INVENTION

1. Field of the Invention

The present invention relates to vertical blinds, and particularly to a device to repair vertical blinds.

2. Description of the Related Art

Vertical blinds are an increasingly popular window treatment for homes and offices. Some of the reasons for the popularity of vertical blinds include basic installation, pleasing aesthetics, simple operation, high light-shielding capability and the fact that vertical blinds are easy to clean. In a typical arrangement, a horizontal track is set above a window, door or other opening. The track has a series of downward extending slat hooks to which the slats are attached so that each slat hangs vertically. Usually the vertical blind slat has an aperture at the top of the slat through which the slat hook is engaged.

One problem with vertical blinds is that the aperture for the admittance of the slat hook may become torn or otherwise damaged. If the slat can no longer be attached to the slat hook, that particular slat must be discarded and replaced with a new slat. Replacement slats can be a costly solution. Furthermore, replacement slats are not always available because manufacturers have ceased making them. Still further, because the color of slats may be altered due to the effect of time or the sun, a new replacement slat does not blend in with the color of the original slats.

An alternative to a replacement slat is to repair the broken slat. Some methods, apparatuses and kits to repair vertical blinds have been proposed. However, such devices and methods involve punching holes into the slat, inserting rivets, or other complicated installation procedures not suited to a homeowner. Another difficulty with some repair kits is they are only suited to particular types of vertical slats.

A device relating to blinds is described in United Kingdom Patent No. 982,256, published Feb. 3, 1965, which shows improvements to Venetian blinds that enable a user to construct their own set of blinds. French Patent Publication No. 2,402,263, published Mar. 30, 1979, describes a display frame for art with a clip-shaped stop at the bottom of the frame.

None of the above inventions and patents, taken either singly or in combination, is seen to describe the instant invention as claimed. Thus, a device to repair vertical blinds solving the aforementioned problems is desired.

### SUMMARY OF THE INVENTION

The device to repair vertical blinds is a simple, cost efficient, and aesthetically pleasing way to repair a slat on a vertical blind set when the mounting hole on one of the slats has been torn or otherwise damaged.

The device is a flat, rectangular body having a crease in the center that divides the body in to two symmetrical flaps. Each flap has a centrally located rectangular aperture that is dimensioned and configured to match the size of the mounting hole on a slat.

The device has an upper surface and a lower surface. A thin strip of adhesive is disposed along the outward edge of the upper surface of each of the flaps. To use the device, the device is folded along the crease. The next step is to position the device over the damaged slat, aligning the apertures with the mounting hole of the damaged slat. The adhesive secures the flaps to opposite sides of the slat. Once the device is installed, the damaged slat may be hung with the hook extending through the hole formed by the aligned apertures, the slat being securely held by the adhesive.

The device is constructed from flexible plastic, although it is contemplated that other bendable materials may be used. The device may be transparent, opaque, or come in a variety of colors.

These and other features of the present invention will become readily apparent upon further review of the following specification and drawings.

### BRIEF DESCRIPTION OF THE DRAWINGS

FIG. 1 is an environmental perspective view of a set of vertical blinds utilizing the device to repair vertical blinds according to the present invention.

FIG. 2 is a perspective view of a set of vertical blinds with one broken slat.

FIG. 3 is a perspective view of the device to repair vertical blinds according to the present invention in an unfolded condition.

FIG. 4 is a perspective view of the device to repair vertical blinds according to the present invention when folded.

FIG. 5 is an exploded, environmental perspective view of the device to repair vertical blinds, showing the process of installing the device onto a broken slat.

FIG. 6 is a perspective view of the device to repair vertical blinds installed on a broken slat.

Similar reference characters denote corresponding features consistently throughout the attached drawings.

### DETAILED DESCRIPTION OF THE PREFERRED EMBODIMENTS

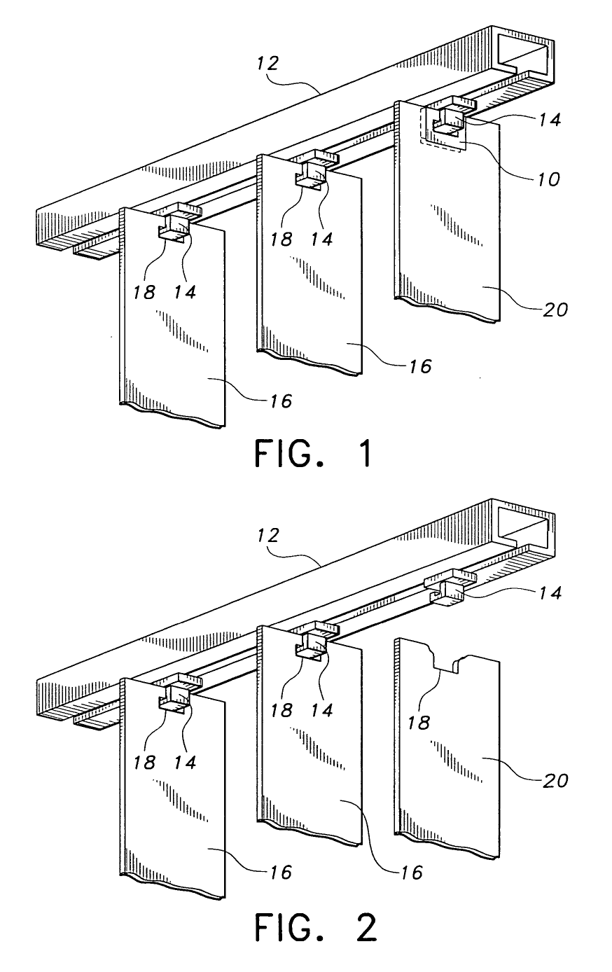

The present invention is a device to repair vertical blinds, designated generally as 10 in the drawings and referred to as the “device” in the following description. Referring to FIGS. 1 and 2, a set of vertical blinds is made up of a track 12 that is attached above a door, window or other opening. The track 12 has a plurality of downwardly extending hooks 14 that slide in the track 12. Each hook 14 supports a slat 16. Each slat 16 has a mounting hole 18 that is centrally located at the top of the slat 16. The mounting hole 18 is receives the hook 14. When the area of the slat 16 between the top of the slat 16 and the mounting hole 18 cracks or breaks off, as shown in FIG. 2, the damaged slat 20 can no longer be used.

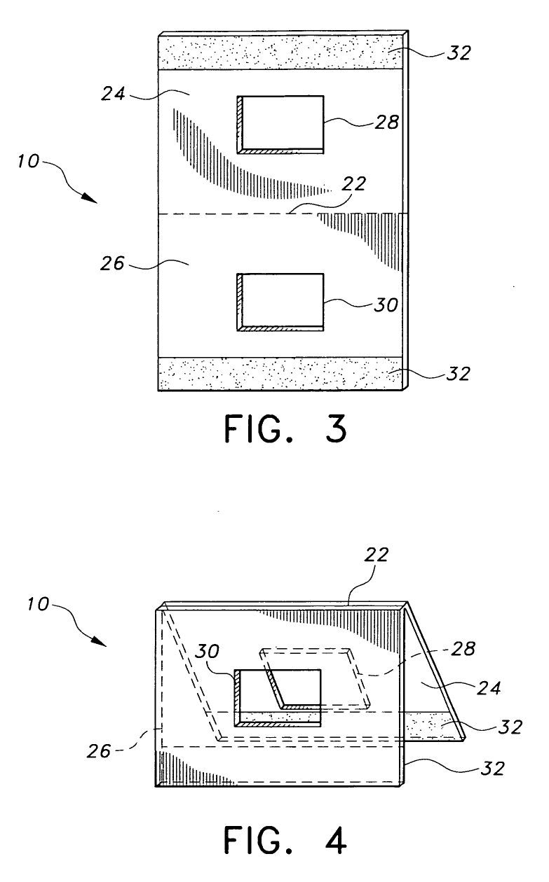

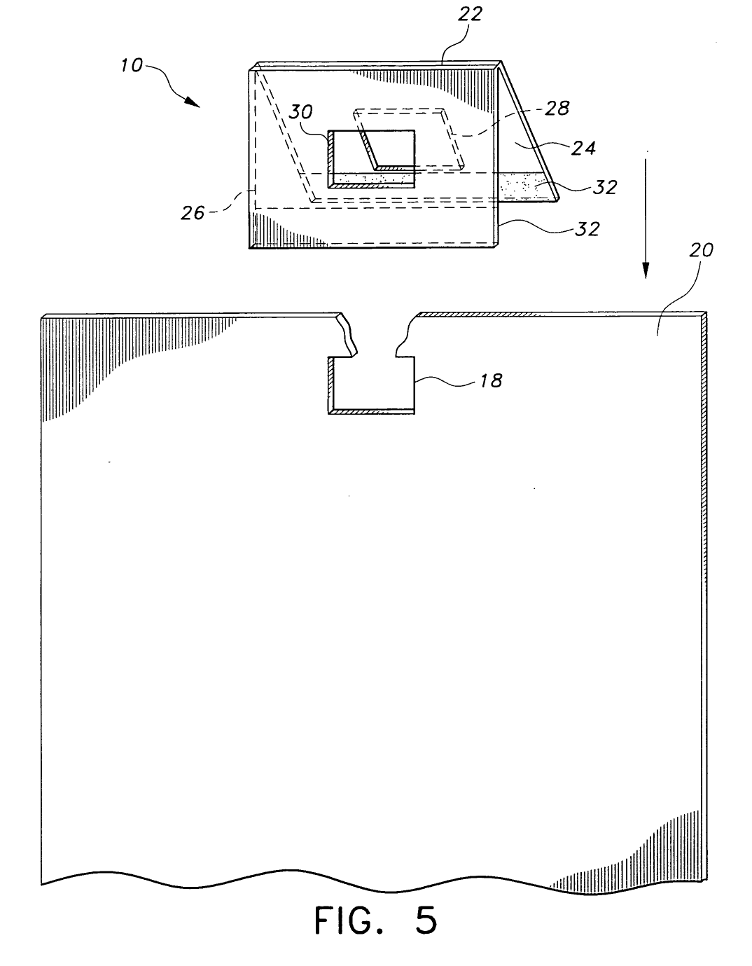

The device 10 is designed to repair slats 16, such as the damaged slat 20 shown in FIG. 2. Referring to FIGS. 3 and 4, the device 10 is a flat, rectangular body having a crease 22 in the center that divides the body into two symmetrical flaps 24, 26. Each flap 24, 26 has a centrally located rectangular aperture 28, 30 that is dimensioned and configured to match the size of a mounting hole 18 on a slat 16.

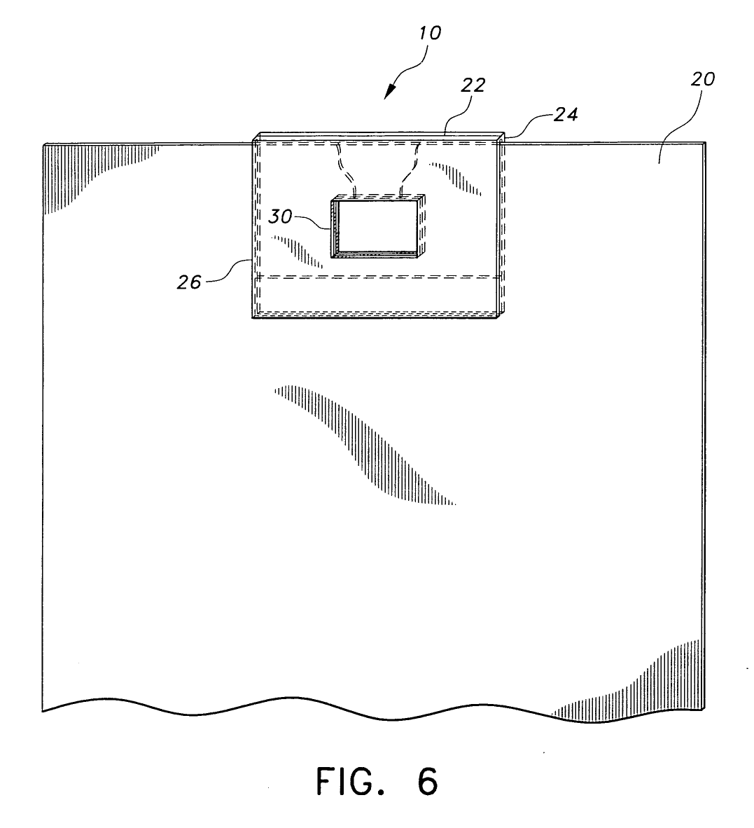

The device 10 has an upper surface and a lower surface. A thin strip of adhesive 32 is disposed along the outward edge of the upper surface of each of the flaps 24, 26. To use the device 10, the device is folded along the crease 22, as shown in FIG. 4. The next step is to position the device 10 over the damaged slat 20 as indicated in FIG. 5. The device 10 is placed over the mounting hole 18 on the damaged slat 20 so that the apertures 28, 30 are in alignment with the mounting hole 18 as shown in FIG. 6. Once properly positioned, the flaps 24, 26 are held in place by the adhesive 32 that sticks to opposite sides of the damaged slat 20. It is preferred that pressure sensitive adhesive be used with device 10, although other types of binding agents may be used. The damaged slat 20 with the device to repair vertical blinds 10 is then hung on the hook 14 as is shown in FIG. 1, the hook 14 being received through the hole defined by the aligned apertures 30.

The device 10 is constructed from flexible plastic, although it is contemplated that other bendable materials be used. The device 10 shown in FIGS. 1-6 is preferably transparent so that the color of the slat is visible through the device 10, although the device 10 may be opaque or come in a variety of colors.

It is to be understood that the present invention is not limited to the embodiments described above, but encompasses any and all embodiments within the scope of the following claims.

We claim:

1. A device for repairing a damaged mounting hole on a slat of a vertical blind set, the device comprising:
a flat rectangular body made of flexible material having an upper surface and a lower surface, the body having a crease dividing the body into two symmetrical flaps, each flap having an outward edge opposite to the crease, each flap having a centrally disposed aperture dimensioned and configured to match the mounting hole of the slat; and
means for attaching the body to the slat with the apertures aligned with the damaged mounting hole.

2. The device according to claim 1, wherein said means for attaching comprises a strip of adhesive disposed on the upper surface of the body along the outward edge of each of the flaps.

3. The device according to claim 2, wherein the adhesive is pressure sensitive adhesive.

4. The device according to claim 1, wherein the material is transparent plastic.

5. The device according to claim 1, wherein the material is opaque plastic.
